(19) United States
(12) Patent Application Publication
(10) Pub. No.: US 2026/0269436 A1
(43) Pub. Date: Sep. 10, 2026

(54) BATTERY MODULE AND BATTERY PACK INCLUDING THE SAME

(71) Applicant: SK On Co., Ltd., Seoul (KR)

(72) Inventors: Jae Kyung PARK, Daejeon (KR); Hui Jun SHIN, Daejeon (KR); Chong Pyo HONG, Daejeon (KR)

(21) Appl. No.: 19/546,452

(22) Filed: Feb. 23, 2026

(30) Foreign Application Priority Data
Mar. 6, 2025 (KR) 10-2025-0028629

(51) Int. Cl. H01M 50/588; H01M 10/658; H01M 50/503; H01M 50/507; H01M 50/519; H01M 50/591; H01M 50/211

(52) U.S. Cl. CPC H01M 50/588; H01M 10/658; H01M 50/503; H01M 50/507; H01M 50/519; H01M 50/591; H01M 50/211

(57) ABSTRACT

A battery module according to an embodiment of the present disclosure includes a cell stack including a plurality of battery cells and at least one protective member disposed between the plurality of battery cells, a plurality of busbars electrically connected to the plurality of battery cells, a busbar frame supporting the busbars and the protective member, an insulating cover facing the busbar frame, and a circuit board connected to the busbars, wherein the circuit board may be connected to the busbars with the insulating cover interposed therebetween.

### CROSS-REFERENCE TO RELATED APPLICATIONS

This application claims benefit of priority to Korean Patent Application No. 10-2025-0028629 filed on Mar. 6, 2025, in the Korean Intellectual Property Office, the disclosure of which is incorporated herein by reference in its entirety.

### BACKGROUND

### 1. Field

The present disclosure relates to a battery module and a battery pack including the same.

### 2. Description of Related Art

Unlike primary batteries, secondary batteries may be charged with and discharged of electricity, so that secondary batteries may be applied to devices within various fields such as digital cameras, mobile phones, laptops, and hybrid cars. Secondary batteries may include nickel-cadmium batteries, nickel-metal hydride batteries, nickel-hydrogen batteries, lithium secondary batteries, or the like.

Such secondary batteries are manufactured as flexible pouch-type battery cells or rigid square or cylindrical can-type battery cells, and are used by electrically connecting a plurality of battery cells. In this case, the plurality of battery cells are disposed inside a housing to form a cell stack in a form in which the plurality of battery cells are stacked, thereby forming a battery device such as a battery module or battery pack.

### SUMMARY

According to an aspect of the present disclosure, a battery module having improved stability, even during thermal runaway, and a battery pack including the same may be provided.

In addition, the battery module of the present disclosure may be widely applied to devices within green technology fields such as electric vehicles, battery charging stations, and solar and wind power generation devices using batteries.

In addition, the battery module of the present disclosure can be used in eco-friendly electric vehicles, hybrid vehicles, and the like, to help ameliorate the effects of climate change by suppressing air pollution and greenhouse gas emissions.

According to an embodiment of the present disclosure, a battery module may include a cell stack including a plurality of battery cells and at least one protective member disposed between the plurality of battery cells; a plurality of busbars electrically connected to the plurality of battery cells; a busbar frame supporting the busbars and the protective member; an insulating cover facing the busbar frame; and a circuit board connected to the busbars, wherein the circuit board may be connected to the busbars with the insulating cover interposed therebetween.

A portion of the circuit board may be provided on an outer surface of the insulating cover.

The circuit board may include a body portion disposed above the busbar frame, and extending in a direction in which the battery cells are stacked, and an extension portion connected to the body portion, a portion of which is connected to the busbar.

The extension portion may include a first extension portion connected to the body portion, and a second extension portion connected to the first extension portion, and connected to the busbar, wherein the first extension portion and the second extension portion may be bent at a first connection point and extend in different directions.

The extension portion may include a first extension portion, a second extension portion, and a third extension portion, the first extension portion may be connected to the body portion, the third extension portion may be connected to the busbar, and the second extension portion may connect the first extension portion and the third extension portion, wherein the first extension portion and the second extension portion may be disposed above the busbar frame.

The extension portion of the circuit board and the busbar may be connected through a coupling portion.

The coupling portion may include a coupling bolt penetrating through the extension portion, the insulating cover, and the busbar, and a coupling nut connected to the coupling bolt.

The coupling nut may be an insert nut.

The coupling portion may further include an insulating member covering a portion through which the coupling bolt penetrates and formed of an insulating material.

The busbar frame may include a slit hole into which the battery cell is inserted, and an insertion hole into which the protective member is inserted.

At least one of opposite ends of the protective member may be provided to protrude further toward the insulating cover than the slit hole.

A length of the protective member extending in a third direction may be formed to be longer than a length of the battery cell extending in a third direction, and the third direction may be a direction perpendicular to a first direction in which the battery cells are stacked and a second direction intersecting lead tabs of the battery cells.

A material of the protective member may be provided with a material for blocking propagation of heat or flames between adjacent battery cells.

According to an embodiment of the present disclosure, a battery pack may include a pack housing, and at least one battery cell disposed in the pack housing, wherein the battery cell may include a cell stack including a plurality of battery cells and at least one protective member disposed between the plurality of battery cells, a plurality of busbars electrically connected to the plurality of battery cells, a busbar frame supporting the busbars and the protective member, an insulating cover facing the busbar frame, and a circuit board connected to the busbars, wherein the circuit board may be connected to the busbars with the insulating cover interposed therebetween.

A length of the protective member extending in a third direction may be formed to be longer than a length of the battery cell extending in a third direction and inserted into the busbar frame, and the third direction may be a direction perpendicular to a first direction in which the battery cells are stacked and a second direction intersecting lead tabs of the battery cell.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a battery module according to according to an embodiment of the present disclosure;

FIG. 2 is an exploded perspective view of a battery module according to according to an embodiment of the present disclosure;

FIG. 3 is an exploded perspective view of a battery module having a housing omitted according to an embodiment of the present disclosure;

FIG. 4 is a perspective view of a battery cell included in a cell stack according to an embodiment of the present disclosure;

FIG. 5 is an exemplary diagram illustrating the disposition of a heat blocking member and a battery cell according to an embodiment of the present disclosure;

FIG. 6A is an enlarged view of portion A of FIG. 3 according to an embodiment of the present disclosure;

FIG. 6B is an enlarged view of portion A of FIG. 3 according to an embodiment of the present disclosure;

FIG. 7A is a perspective view of a battery module according to an embodiment of the present disclosure;

FIG. 7B is a side cross-sectional view of a battery module according to an embodiment of the present disclosure;

FIGS. 8A and 8B are a diagram illustrating a circuit board according to an embodiment of the present disclosure;

FIGS. 9A and 9B are a diagram illustrating a circuit board according to an embodiment of the present disclosure; and

FIG. 10 is a perspective view of a battery pack according to an embodiment of the present disclosure.

### DETAILED DESCRIPTION

Prior to the detailed description of the present disclosure, the terms or words used in the present specification and claims described below should not be construed as being limited to a common or dictionary meaning, and the inventor intends to use his/her invention in the best way. Based on the principle that terms may be properly defined for description, they should be interpreted as meanings and concepts consistent with the technical spirit of the present disclosure. Therefore, the embodiments described in this specification and the configurations shown in the drawings are only the most preferred embodiments of the present disclosure, and do not represent all of the technical spirit of the present disclosure, so it should be understood that there may be various equivalents and modifications that can be substituted therefore at the time of this application.

Hereinafter, preferred embodiments of the present disclosure will be described in detail with reference to the attached drawings. In this case, it should be noted that in the attached drawings, the same components are indicated by the same reference symbols whenever possible. In addition, detailed descriptions of functions and configurations known in the art that may obscure the gist of the present disclosure will be omitted. For the same reason, in the accompanying drawings, some components are exaggerated, omitted, or schematically shown, and the size of each component does not entirely reflect the actual size. For example, in this specification, expressions such as upper side, upper portion, upper, lower side, lower portion, lower, side surface, and the like, are illustrated based on the illustration in the drawing, and may be expressed differently when the direction of the object is changed.

Hereinafter, the present disclosure will be described in detail with reference to the attached drawings. However, these are merely an example and the present disclosure is not limited to the specific embodiments described as examples.

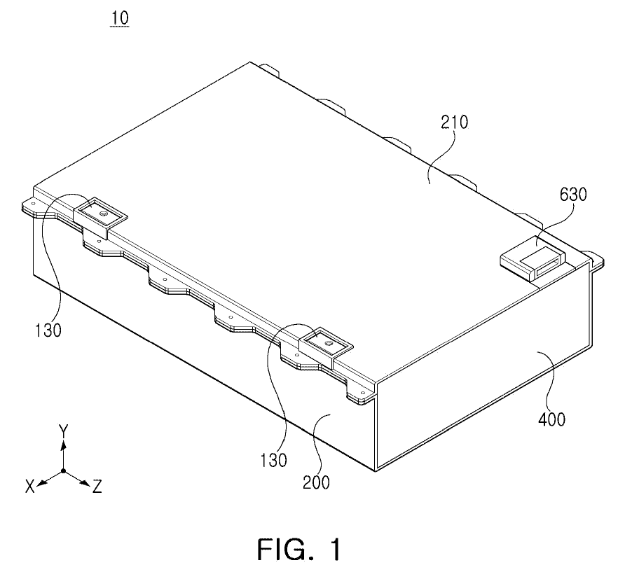

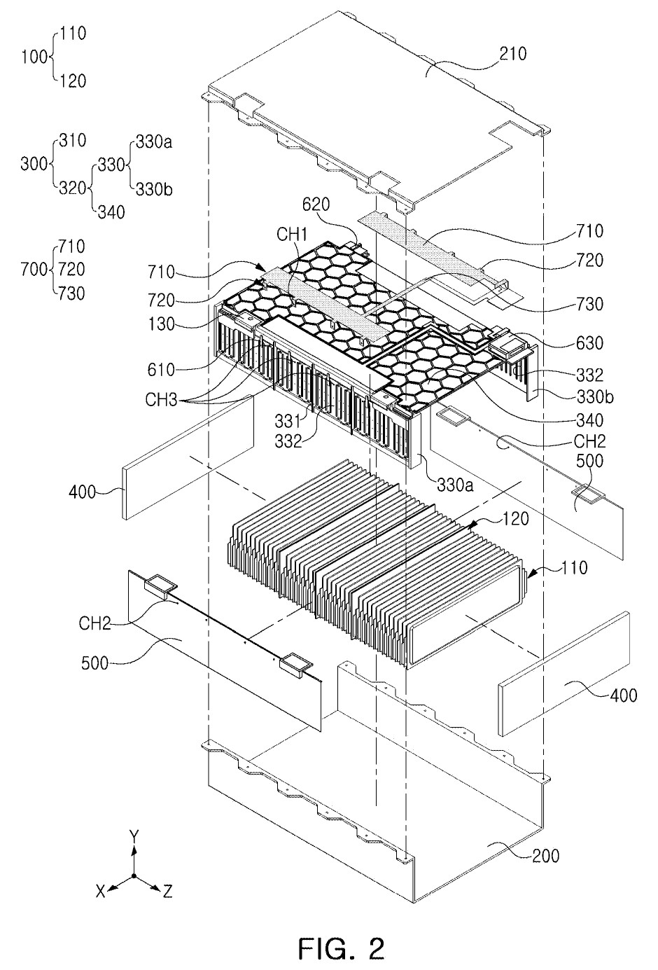

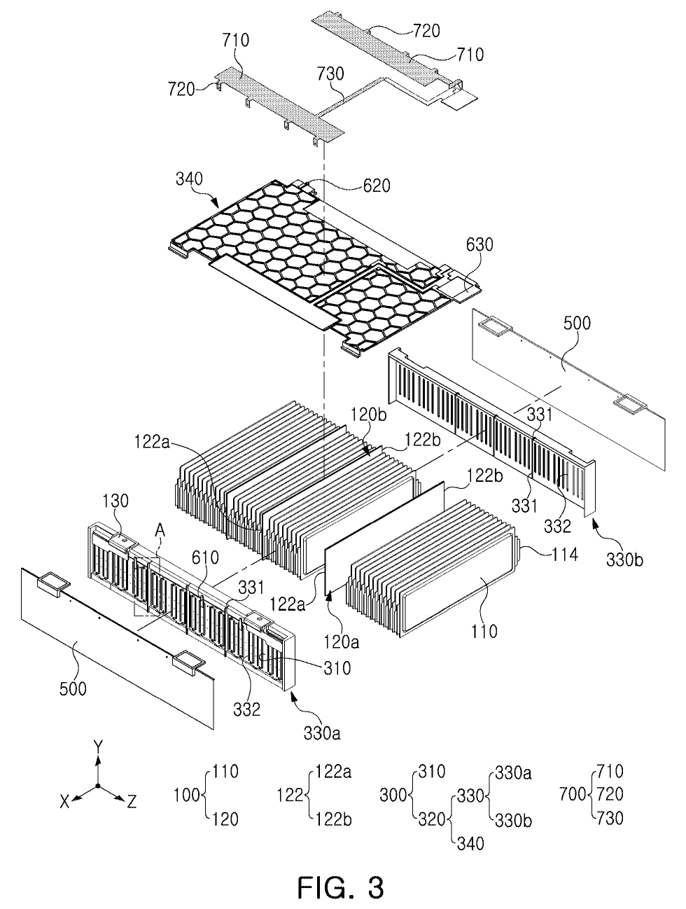

FIG. 1 is a perspective view of a battery module 10 according to an embodiment of the present disclosure, FIG. 2 is an exploded perspective view of a battery module 10 according to an embodiment of the present disclosure, and FIG. 3 is an exploded perspective view of a battery module 10 having a module housing 200 omitted according to an embodiment of the present disclosure.

Referring to FIGS. 1 to 3, the battery module 10 may include a cell stack 100 including a plurality of battery cells 110, a module housing 200 having an internal space to accommodate the battery cells 110, a busbar assembly 300 electrically connected to the battery cells 110, and an end cover 400 coupled to the module housing 200.

The plurality of battery cells 110 accommodated in the battery module 10 may be stacked in one direction (e.g., a Z-axis direction of FIG. 2) to form at least a portion of the cell stack 100.

Here, a stacking direction of the battery cells 110 may be referred to as a Z-axis direction or a first direction, a direction intersecting lead tabs 114 protruding in different directions of the battery cells 110 may be referred to as an X-axis direction or a second direction, and a direction, perpendicular to the Z-axis direction or the first direction and the X-axis direction or the second direction may be referred to as a third direction or a Y-axis direction.

Each battery cell 110 may be configured to output or store electrical energy. In the cell stack 100, the battery cells 110 may be electrically connected to each other.

The cell stack 100 may include one or more battery cells 110.

The battery cell 110 may be configured to convert chemical energy into electrical energy to supply power to an external circuit, or to receive power from the outside and convert electrical energy into chemical energy to store electricity therein.

For example, the battery cell 110 may be comprised of a nickel metal hydride (Ni-MH) battery or a lithium ion (Li-ion) battery that can be charged with and discharged of electricity, but an embodiment thereof is not limited thereto.

In embodiments, the plurality of battery cells 110 may be stacked side by side and be electrically connected to each other.

The battery cell 110 included in the cell stack 100 may be a pouch 111 type battery cell 110.

For example, the battery cell 110 may be configured so that an electrode assembly 113 including a plurality of electrode plates are accommodated within a pouch 111, and a lead tab 114 is exposed to one side of the pouch 111. The lead tab 114 of the battery cell 110 may be electrically connected to a busbar 310 of a busbar assembly 300.

However, the specific structure or shape of the battery cell 110 is not limited to that illustrated in the drawing. For example, the battery cell 110 may be configured as a cylindrical battery cell 110 or a square battery cell 110.

As a large number of battery cells 110 are stacked in the battery module 10, there may be a risk that damage may be applied to another battery cell 110 by an event situation occurring in one battery cell 110 (e.g., a situation in which high temperature gases or flames are generated, or the battery cell 110 expands abnormally).

To prevent this, the cell stack 100 may further include a protective member 120 disposed between the battery cells 110.

The protective member 120 may include a material for blocking heat and serve to block heat propagation between the battery cells 110.

For example, the protective member 120 may include a material for blocking heat, thereby preventing heat propagation between adjacent battery cells 110. Alternatively, the protective member 120 may include a material for applying surface pressure to the battery cell 110, thereby performing a function of suppressing expansion of the battery cell 110.

For example, the protective member 120 may include at least one of mica sheet, silicate, graphite, alumina, ceramic wool (or super wool), and aerogel.

The plurality of battery cells 110 included in the cell stack 100 may be electrically connected to each other via a busbar assembly 300. At least a portion of the busbar assembly 300 may be disposed to face the cell stack 100 in a direction, perpendicular to the cell stacking direction.

Alternatively, the protective member 120 may be configured to apply surface pressure to the battery cell 110 by including a material for compressing the battery cell 110 having a predetermined elasticity.

Accordingly, the protective member 120 may prevent the battery cell 110 from expanding excessively.

For example, the protective member 120 may include at least one of polyurethane, silicone, and rubber.

The busbar assembly 300 may include a busbar 310 electrically connecting one battery cell 110 to another battery cell 110 and a support frame 320 supporting the busbar 310.

The busbar 310 may be formed of a conductive material, and may serve to electrically connect the plurality of battery cells 110 to each other.

The busbar 310 may be electrically connected to a lead tab 114 of the battery cell 110. Various welding methods, including laser welding, may be used to connect the busbar 310 and the lead tab 114.

However, the connection method is not limited to welding, and any method that can electrically conduct electricity between two metal materials may be performed.

A portion of the busbars 310 of the busbar assembly 300 may have a terminal portion 130 that can be electrically connected to a circuit outside of the battery module 10.

Here, the terminal portion 130 may be exposed to the outside of the battery module 10 through an opening of a module housing 200.

The busbar 310 may be fixed to a support frame 320.

Here, at least a portion of the support frame 320 may be formed of an insulating material to prevent unintended short circuits from occurring between the plurality of busbars 310. The support frame 320 may face at least one side of the cell stack 100.

The battery module 10 may further include a circuit board 700 connected to one or more sensing members for detecting an operating state, an environmental state, and the like, of the battery cells 110.

For example, the sensing members may include a temperature sensor 620 for measuring a temperature of an adjacent portion (which may mean at least one of an internal space of the battery module or the battery cells 110), or a sensing terminal 610 for measuring a voltage of the battery cells 110.

Meanwhile, although the term ‘sensing members’ is used in the present specification, this is for convenience and may mean ‘one or more sensing members.’

In addition, in the present specification, one or more sensing members connected to the circuit board 700 may be collectively referred to as a “sensor unit.” That is, the sensor unit may refer to one or more sensing members.

Here, the sensor unit (sensing member) may include at least one of the temperature sensor 620 and the sensing terminal 610 described above, as well as various sensing members (sensors).

For example, the sensing element may include any sensor for measuring information values for at least one of the battery cells 110 or the battery module 10, such as a pressure sensor, a humidity sensor, or a shock detection sensor.

In addition, the circuit board 700 described in the present disclosure may mean a sensing circuit board (or a circuit board for sensing 700), as a circuit board 700 to which one or more sensing members described above are connected.

The circuit board 700 according to an embodiment of the present disclosure may be coupled to a busbar assembly 300.

More specifically, the circuit board 700 may be coupled to the support frame 320 so that a position thereof may be fixed, and at least a portion of the circuit board 700 may be coupled to the busbar 310 through the outside of an insulating cover 500.

Meanwhile, since the circuit board 700 according to an embodiment of the present disclosure is coupled to a busbar assembly 300 as described below, the busbar assembly 300 to which the circuit board 700 is coupled may be conveniently referred to as a “busbar assembly 300.”

Information detected by sensing members connected to the circuit board 700 may be transmitted to an external electronic element (e.g., a Battery Management System (BMS) of the battery module 10 through a connector 630 electrically connected to the circuit board 700.

The sensing members connected to the circuit board 700 may receive information from the outside of the battery module 10 through a connector 630 electrically connected to the circuit board 700.

At least a portion of the circuit board 700 may be formed of a flexible printed circuit board (FPCB). Accordingly, at least a portion of the circuit board 700 may be configured to be bendable or foldable.

Here, the battery module 10 according to an embodiment of the present disclosure may include a cell stack 100 including a plurality of battery cells 110, and at least one protective member 120 disposed between the plurality of battery cells 110, a plurality of busbars 310 electrically connected to the plurality of battery cells 110, a busbar frame 330 supporting the busbars 310 and the protective member 120, an insulating cover 500 facing the busbar frame 330, and a circuit board 700 connected to the busbars 310, wherein the circuit board 700 may be connected to the busbars 310 with the insulating cover 500 interposed therebetween.

Accordingly, a portion of the circuit board 700 may be provided on an outer surface of the insulating cover 500.

The circuit board 700 is coupled to the busbar 310 on the outside of the insulating cover 500, so that the blocking portion 122 of the protective member 120 may be continuously inserted thereinto from an upper portion to a lower portion of the busbar frame 330 to block the connection between terminals, thereby preventing high-temperature gases or flames from flowing indiscriminately near the cell stack 100 in a thermal runaway situation.

Referring again to FIGS. 1 to 3, a module housing 200 may provide an internal space in which one or more cell stacks 100 may be accommodated. The module housing 200 may be formed of a material having a predetermined rigidity to protect the cell stack 100 and other electrical components accommodated in the internal space from external impacts.

For example, the module housing 200 may include a metal material such as aluminum.

An upper cover 210 may be coupled to an upper side of the housing 200 to protect an upper side of the cell stack 100.

However, a structure of the module housing 200 is not limited thereto, and may be of any shape as long as the module housing 200 may have an internal space in which at least one cell stack 100 may be accommodated.

For example, the module housing 200 may be formed integrally with the upper cover 210 and configured as an integral monoframe with both sides open.

An end cover 400 may be coupled to one open side of the module housing 200.

For example, as illustrated in FIG. 2, the end cover 400 may be provided in pairs and respectively coupled to both sides of the module hosing 200.

The end cover 400 may be coupled to the module housing 200 to form the exterior of the battery module 10 together with the module housing 200. The end cover 400, like the module housing 200, may include a metal material such as aluminum.

To prevent the busbar assembly 300 and the module housing 200 and the upper cover 210 from being electrically short-circuited, the battery module 10 may include an insulating cover 500.

For example, the insulating cover 500 may be disposed to face the busbar assembly 300 between the busbar assembly 300 and the module housing 200.

The insulating cover 500 may include an insulating material, thereby preventing electrical connection from occurring between the busbar assembly 300 and the module housing 200.

For example, the insulating cover 500 may be formed of a plastic injection molded product including polypropylene, modified polyphenylene oxide, or the like.

However, a material of the insulating cover 500 is not limited thereto.

As the insulating cover 500 is disposed, it is possible to prevent an electrical short circuit from occurring between the cell stack 100 and the module housing 200, or between the busbar 310 and the module housing 200.

A heat dissipation member (not shown) may be disposed between the cell stack 100 and the module housing 200.

The heat dissipation member (not shown) may be disposed so that one surface of the heat dissipation member contacts the cell stack 100, and the other surface thereof, opposite to the one surface contacts the module housing 200.

The heat dissipation member (not shown) may be provided with a thermal adhesive.

The heat dissipation member (not shown) may fill a space between the cell stack 100 and the module housing 200 to enable more active heat transfer through conduction. Accordingly, the heat dissipation efficiency of the battery module 10 may be increased.

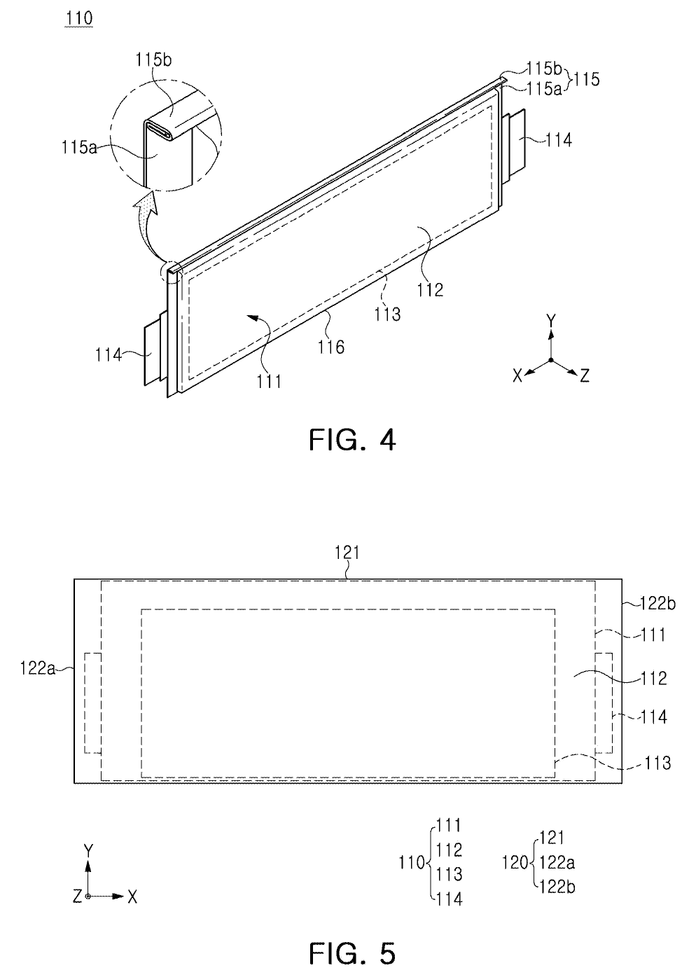

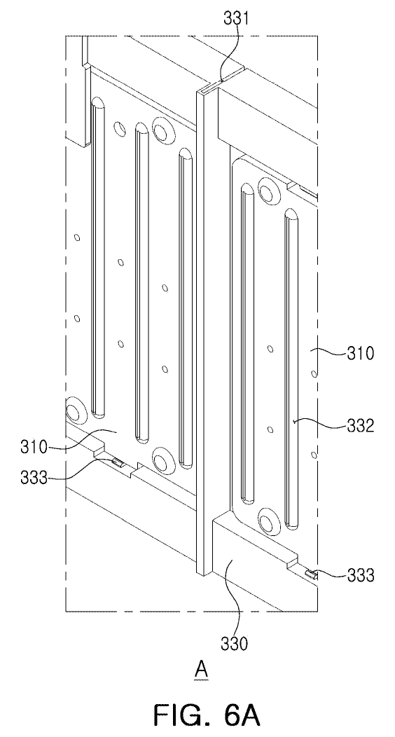

FIG. 4 is a perspective view of a battery cell 110 included in a cell stack 100 according to an embodiment of the present disclosure, and FIG. 5 is an exemplary diagram illustrating the disposition of a heat blocking member and a battery cell 100 according to an embodiment of the present disclosure.

Referring to FIGS. 4 and 5 along with FIGS. 1 to 3, the cell stack 100 may include a plurality of battery cells 110 and a plurality of protective members 120 stacked in a first direction (Z-axis direction).

Referring to FIG. 4, the battery cell 110 may be a pouch-type secondary battery having a structure in which an electrode assembly 113 is accommodated within a pouch 111.

In the pouch 111 type secondary battery, the electrode assembly 113 and an electrolyte (not shown) may be accommodated within the pouch 111 formed by forming one sheet or a plurality of exterior materials.

The pouch 111 may include an electrode accommodating portion 112 in which the electrode assembly 113 and an electrolyte (not shown) are accommodated, a sealing portion 115 formed around the electrode accommodating portion 112, and a lead tab 114 electrically connected to the electrode assembly 113 and exposed to the outside of the pouch 111.

The electrode accommodating portion 112 provides an internal space in which the electrode assembly 113 and the electrolyte (not shown) are accommodated. The electrode assembly 113 may have a form in which a plurality of positive electrode plates and a plurality of negative electrode plates are stacked with a separator interposed therebetween.

The sealing portion 115 may formed by bonding the pouch 111 may be disposed along at least a portion of a peripheral portion of the electrode accommodating portion 112.

The sealing portion 115 may include a first sealing portion 115a formed in a portion in which the lead tab 114 is disposed, and a second sealing portion 115b formed in a portion in which the lead tab 114 is not disposed.

In order to increase bonding reliability of the sealing portion 115 and minimize an area of the sealing portion 115, the sealing portion 115 may be formed in a form, folded at least once, as illustrated in the partially enlarged view of FIG. 4.

The cell stack 100 may further include a plurality of battery cells 110 and a plurality of protective members 120 facing each other in a first direction (Z-axis direction).

Referring to FIGS. 2 and 3, the plurality of protective members 120 may be disposed side by side at a predetermined interval in a cell stacking direction (e.g., Z-axis direction). One or more battery cells 110 may be disposed between two adjacent protective members 120.

Here, four battery cells 110 are stacked between two blocking members, but this is merely an example, and three or less or five or more battery cells 110 may be disposed between the two blocking members.

A material of the protective member 120 may be prepared from a material that can block heat and/or flame propagation between adjacent battery cells 110.

The protective member 120 may include a material having at least one property among flame retardancy, heat resistance, heat insulation, and insulating properties.

Here, the heat resistance properties may mean a property not melting and changing shapes thereof even at temperatures of 300 or higher Celsius, and the heat insulation properties may mean a property of having thermal conductivity of 1.0 W/mK or less.

For example, the material of the protective member 120 may include at least one of mica sheet, silicate, graphite, alumina, ceramic wool (or super wool), and aerogel.

The material of the protective member 120 is not limited to the materials described above, and may be formed of any material that can maintain a shape thereof in a thermal runaway situation of the battery cell 110, and prevent heat or flames from propagating to other adjacent battery cells 110.

To maximize the energy density of the cell stack 100, a thickness of the protective member 120 may be smaller than a thickness of one battery cell 110. Here, the thickness may refer to a length of the cell stacking direction.

Meanwhile, the protective member 120 may be comprised of a combination of members having different properties.

For example, the protective member 120 may be comprised of a combination of the above-described material for heat blocking and a material with a predetermined elasticity. Therefore, the protective member 120 may prevent excessive expansion of the battery cell 110.

For example, the protective member 120 may further include at least one of polyurethane, silicone, and rubber, and may pressurize the battery cell 110 by using the elasticity of the materials.

Referring to FIGS. 2, 3, and 5, the protective member 120 may face the electrode accommodating portion 112 of the battery cell 110, and may include a body portion 121 provided to extend in the second direction (X-axis direction) and a blocking portion 122 provided at opposite ends of the body portion 121.

The body portion 121 of the protective member 120 may face the electrode accommodating portion 112 in the first direction (Z-axis direction), and may block heat propagation between adjacent battery cells 110.

The blocking portion 122 of the protective member 120 may refer to a portion extending in the second direction (X-axis direction) from opposite ends of the body portion 710.

As the blocking portion 122 is formed, a length of the protective member 120 in the second direction (X-axis direction) according to embodiments may be provided to be longer than a length of the electrode accommodating portion 112 in the second direction (X-axis direction).

In particular, unlike the conventional technology, since the circuit board 700 contacts the busbar 310 through the outside of the insulating cover 500, the blocking portion 122 may be continuously connected to the upper and lower portions of the busbar frame 330 without interfering with the circuit board 700.

For example, the blocking portion 122 may be configured to extend in a second direction (X-axis direction) from an end of the body portion 710 so that the end is inserted into the busbar frame 330.

The blocking portion 122 may include a first blocking portion 122a inserted into the busbar frame 330 and a second blocking portion 122b provided on the opposite side of the first blocking portion 122a with respect to the body portion 710.

Referring to FIGS. 2, 3 and 5, the first blocking portion 122a may be inserted into the busbar frame 330, and may protrude further in the second direction (X-axis direction) rather than the busbar 310.

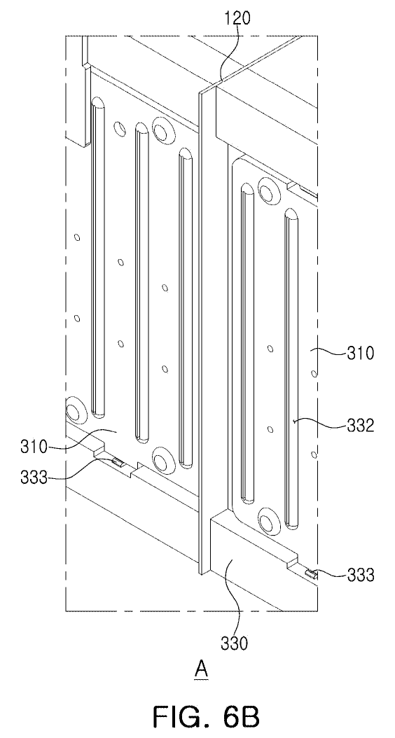

FIG. 6A is an enlarged view of portion A of FIG. 3 according to an embodiment of the present disclosure, and FIG. 6B is an enlarged view of portion A of FIG. 3 according to another embodiment of the present disclosure.

Referring to FIG. 6A, along with FIGS. 2, 3 and 5, the busbar frame 330 may include a slit hole 332 into which a battery cell 110 is inserted and an insertion groove 331 into which a protective member 120 is inserted.

More specifically, a slit hole 332 into which a lead tab 114 of the battery cell 110 is inserted may be disposed in the busbar frame 330, and an insertion hole 331 into which a blocking portion 122 is inserted may be disposed in the busbar frame 330.

Here, at least one of opposite ends of the protective member 120 may be provided to protrude further toward the insulating cover 500 than the slit hole 332.

More specifically, the blocking portion 122 provided at the end of the protective member 120 may be inserted into the slit hole 332, and the blocking portion 122 of the protective member 120 may be provided to protrude toward the insulating cover 500. As the protective member 120 is disposed to protrude toward the insulating cover 500, adjacent battery cells 100 with the protective member 120 interposed therebetween may be physically isolated, and the protective member 120 may reliably block propagation of heat or flames between the adjacent battery cells in the first direction (Z-axis direction).

Referring to FIG. 6B, along with FIGS. 2, 3 and 5, in another embodiment of the present disclosure, the protective member 120 may be provided to protrude through the busbar frame 330 toward the insulating cover 500, thereby physically isolating adjacent battery cells 110 with the protective member 120 interposed therebetween. In addition, when inserted into the busbar frame 330, the first blocking portion 122a may protrude further in a second direction (X-axis direction) rather than the busbar 310.

In other words, a distance between a side surface of the module housing 200 and the first blocking portion 122a in the second direction (X-axis direction) may be smaller than a distance between the side surface of the module housing 200 and the busbar 310 in the second direction (X-axis direction).

The first blocking member 122a may be inserted into the busbar frame 330 and disposed between two adjacent busbars 310. Therefore, the first blocking member 122a may prevent the two busbars 310 from physically contacting each other.

Here, the first blocking portion 122a is configured to protrude further in the second direction (X-axis direction) rather than the busbar 310, so that an unintended short circuit may be physically prevented from occurring between the busbars 310 in a thermal runaway situation.

When the first blocking portion 122a may be formed on one side of the body portion 710, the second blocking portion 122b may be formed on the other side thereof opposite to the one side of the body portion 710.

Here, unlike the first blocking portion 122a, the second blocking portion 122b may not have a portion inserted into the busbar frame 330.

However, an embodiment thereof is limited thereto, and if necessary, the second blocking portion 122b may also be configured to be inserted into the busbar frame 330.

The second blocking portion 122b may be disposed to face an inner surface of the busbar frame 330 so as not to interfere with the busbar 310.

In a plurality of protective members 120, the first blocking portion 122a of a portion of the protective members 120 may be inserted into a first busbar frame 330a, and other portions of the protective members 120 may be inserted into a second busbar frame 330b.

For example, referring to FIGS. 2 and 3, a pair of busbar frames 330 may include a first busbar frame 330a and a second busbar frame 330b, disposed to be spaced apart from each other in the second direction (X-axis direction), and in the plurality of protective members 120, the first blocking portion 122a may be inserted into the first busbar frame 330a, and the second blocking portion 122b may be inserted into the second busbar frame 330b.

Meanwhile, in an embodiment not illustrated, a plurality of protective members 120 may be inserted into at least one busbar frame 330.

In another embodiment not illustrated, the first protective member 120a and the second protective member 120b may be disposed alternately in the first direction (Z-axis direction), and the first protective member 120a and the second protective member 120b may intersect each other, and be inserted into one busbar frame (330a, 330b).

More specifically, the first blocking portion 122a of the first protective member 120a may be inserted into the first busbar frame 330a, and the second blocking portion 122b of the second protective member 120b may be inserted into the second busbar frame 330b.

The first blocking portion 122a and the second blocking portion 122b may serve to block gases or flames generated in a thermal runaway situation from flowing in the first direction (Z-axis direction) near the cell stack 100.

Since the gases or flames is blocked from flowing in the first direction (Z-axis direction) by the first blocking portion 122a and the second blocking portion 122b, it can be naturally induced to flow in a direction perpendicular to the first direction (Z-axis direction) (for example, in a third direction (Y-axis direction) in which an upper case and a lower case face each other).

In addition, a length of the protective member 120 extending in the third direction (Y-axis direction) may be formed to be longer than a length of the battery cell 110 extending in the third direction (Y-axis direction).

Here, the third direction (Y-axis direction) may be a direction perpendicular to a first direction (Z-axis direction) in which the battery cells 110 are stacked and a second direction (X-axis direction) intersecting lead tabs of the battery cells 110.

In other words, the protective member 120 may be formed to be longer than the battery cell 110 in the third direction (Y-axis direction), and may be inserted into the busbar frame 330. Thereby, the protective member 120 may block the battery cells 110 disposed adjacently with the protective member 120 interposed therebetween. As described above, the battery module 10 according to the embodiments may include a protective member 120 having a blocking portion 122, thereby preventing high-temperature gases or flames from flowing indiscriminately near the cell stack 100 in a thermal runaway situation.

In particular, a protective member 120 according to an embodiment of the present disclosure may be inserted from an upper portion of the busbar frame 330 into a lower portion thereof, to block an indiscriminate flow of high-temperature gases or flames between the busbar frame 330 and the cell laminate 100, and induce a flow path thereof in a certain direction.

For example, high-temperature gases or flames may be induced to flow through a venting hole provided in the upper cover 210.

Referring to FIGS. 2, 3 and 6A, a busbar frame 330 may include a slit hole 332 into which the busbar 310 is inserted and an insertion groove 331 into which the blocking portion 122 of the protective member 120 is inserted.

The busbar frame 330 may further include a rib structure supporting the busbar 310 in an upper portion and a lower portion thereof.

More specifically, the busbar frame 330 may further include a rib portion 333 supporting the busbar 310 by contacting the upper and lower portions of the busbar 310.

The rib portion 333 may have grooves formed in the first direction (Z-axis direction) dispose at a predetermined interval in the second direction (X-axis direction). Thereby, by increasing frictional force between the rib portion 333 and the busbar 310 supported in contact with each other in the upper and lower portions, the busbar 310 may be prevented from being separated from the rib portion 333 and moving in the second direction (X-axis direction).

The busbar frame 330 may support the busbar 310 in the upper and lower portions of the busbar 310 without a structure protruding in the second direction (X-axis direction), thereby enhancing the effect of blocking the flow of high-temperature gases or flames due to the coupling of the protective member 120 and the busbar frame 330.

The blocking portion 122 of the protective member 120 has properties such as flame retardancy, heat resistance, and heat insulation, so the blocking portion 122 may maintain a shape thereof even in a high-temperature environment.

In a thermal runaway situation, gases or flames generated from the cell stack 100 may be blocked by the blocking portion 122 of the protective member 120 and flow along a surface of the blocking portion 122.

For example, since the blocking portion 122 extends adjacent to an inner surface of the busbar frame 330, a venting path may be induced to exit to the peripheral portion of the busbar frame 330 by the blocking portion 122.

The venting path formed on the inside of the busbar frame 330 by the blocking member 122 may be formed in a direction (Y-axis direction) toward an upper side of the battery module 10 by blocking the flow thereof in the first direction (Z-axis direction).

That is, the blocking portion 122 extending in a second direction (X-axis direction) from the body portion 710 may block gases or flames from flowing in a first direction (Z-axis direction), perpendicular to the second direction (X-axis direction), while inducing the gases or flames to flow in a third direction (Y-axis direction).

In particular, as gases or flames is continuously generated, the protective member 120 may induce the flow of gases or flames toward an upper direction of the battery module 10.

As described above, the protective member 120 may prevent gases or flames from propagating in a cell stacking direction near the cell stack 100, thereby preventing the battery cells 110 from being ignited in a chain reaction by gases or flames.

The busbar frame 330 may be formed of a material that is relatively more susceptible to high temperatures than the protective member 120.

For example, when the busbar frame 330 includes a plastic material, the busbar frame 330 may be structurally collapsed by high-temperature gases or flames generated in a thermal runaway situation.

In this case, there is a risk that gases or flames may propagate indiscriminately through an empty space formed when the busbar frame 330 collapses. In such a situation, the protective member 120 may induce the flow path of gases or flames to a safe path.

Even when the busbar frame 330 melts due to high-temperature gases or flames, the protective member 120 may not melt, and the venting path may be formed to face the third direction (Y-axis direction) along the protective member 120.

Thereby, the protective member 120 may prevent an electrical short circuit from occurring between the busbars 310 due to flowing gases or flames.

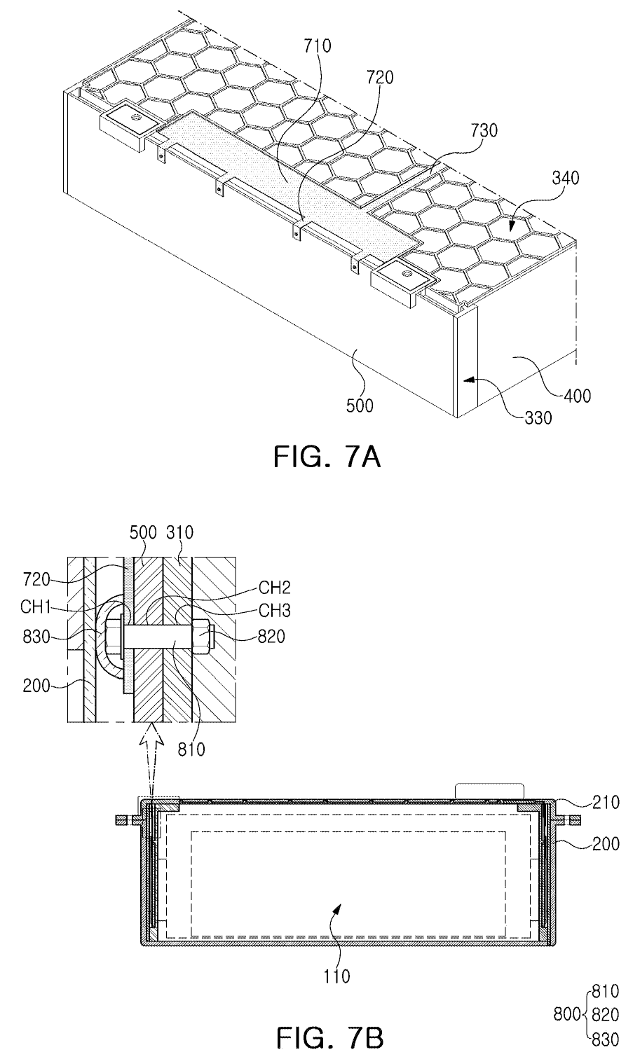

FIG. 7A is a perspective view of a battery module 10 having a circuit board according to an embodiment of the present disclosure, and FIG. 7B is a side cross-sectional view of the battery module 10 according to an embodiment of the present disclosure.

Referring to FIGS. 7A and 7B, a circuit board 700 according to an embodiment of the present disclosure may be connected to a busbar 310 provided on the inside of an insulating cover 500 from the outside of the insulating cover 500.

Referring to FIG. 7B, a battery module 10 according to an embodiment of the present disclosure may further include a coupling portion 800 connecting the circuit board 700 and the busbar 310.

The coupling portion 800 according to an embodiment of the present disclosure may be configured to electrically connect a circuit board 700 and a busbar 310 disposed above the busbar frame 330 and an outer surface of the insulating cover 500.

In other words, an extension portion 720 of the circuit board 700 and the busbar 310 may be connected through the coupling portion 800.

The coupling portion 800 may include a coupling bolt 810 penetrating through the extension portion 720, the insulating cover 500, and the busbar 310, and a coupling nut 820 connected to the coupling bolt 810.

More specifically, the coupling bolt 810 may be connected to the coupling nut 820 by penetrating through a coupling hole CH respectively provided in the extension portion 720, the insulating cover 500, and the busbar 310.

Here, the coupling hole CH may include a first coupling hole CH1 provided in the extension portion 720 of the circuit board 700, a second coupling hole CH2 provided in the insulating cover 500, and communicating with the first coupling hole CH1, and a third coupling hole CH3 provided in the busbar 310, and communicating with the first coupling hole CH1 and the second coupling hole CH2.

The coupling bolt 810 may be coupled to the coupling nut 820 through the first coupling hole CH1, the second coupling hole CH2, and the third coupling hole CH3. In other words, the coupling bolt 810 and the coupling nut 820 may connect the extension portion 720 of the circuit board 700 and the busbar 310 provided with the insulating cover 500 interposed therebetween.

Here, the coupling nut 820 may be an insert nut.

For example, the coupling nut 820 may be provided as an insert nut which is inserted into and supported by the busbar 310. When coupling the extension portion 720, the insulating cover 500, and the busbar 310 with the coupling bolt 810 and the insert nut, there may be an advantage in that there is no portion protruding toward the busbar 310, while coupling the extension portion 720, the insulating cover 500, and the busbar 310.

The coupling portion 800 may further include an insulating member 830 covering a portion through which the coupling bolt 810 penetrates, and formed of an insulating material.

In order to enhance the insulation performance of the coupling portion 800 penetrating through the insulating cover 500, the coupling portion 800 may further include an insulating member 830 formed of an insulating material, and covering a portion of the coupling bolt 810.

For example, the insulating member 830 may be provided as a thin flat or film-type member that can cover an upper portion of the coupling bolt 810 exposed to a side of the extension portion 720, so that at least a portion thereof may be coupled to the insulating cover 500 to protect the coupling bolt 810.

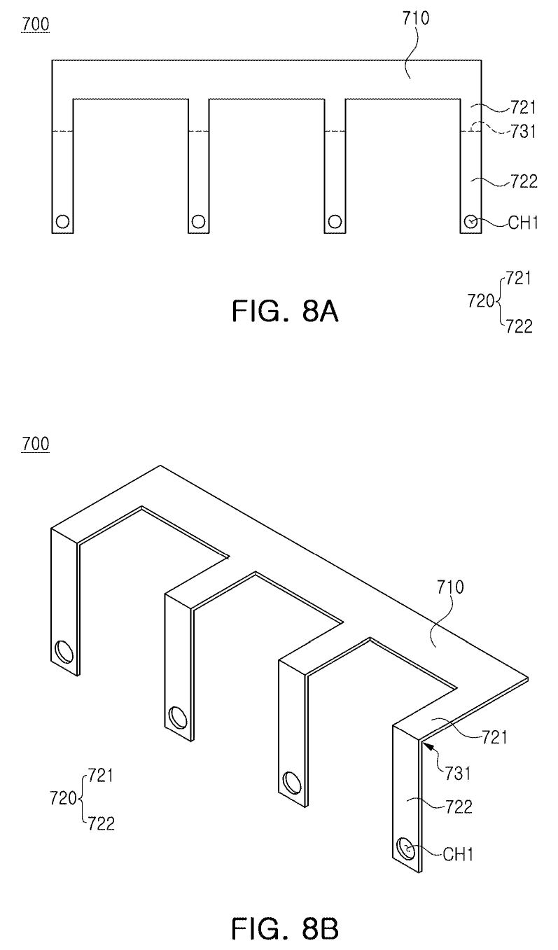

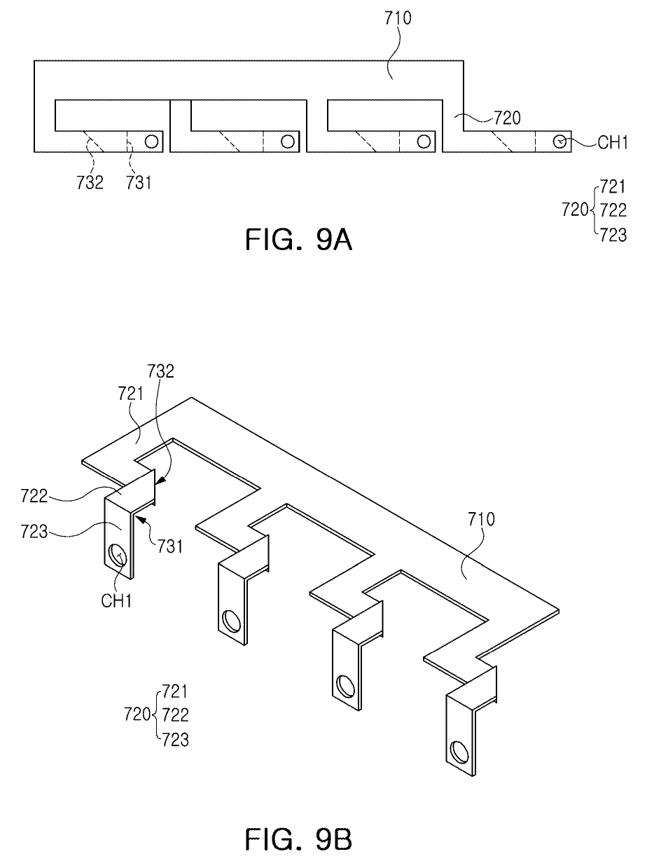

FIGS. 8A and 8B are a diagram illustrating an example of a circuit board 700 according to an embodiment of the present disclosure, and FIGS. 9A and 9B are a diagram illustrating an example of a circuit board 700 according to an embodiment of the present disclosure.

Hereinafter, a circuit board 700 according to an embodiment of the present disclosure will be described in more detail with reference to FIGS. 8 to 9, along with FIGS. 2, 3, 7A and 7B.

Referring to FIGS. 7A and 7B, along with FIGS. 2 and 3, a battery module 10 according to an embodiment of the present disclosure may include a circuit board 700 extending in a first direction (Z-axis direction) in which battery cells 110 are stacked, disposed above a busbar frame 330 and on the outside of an insulating cover 500, and connected to a busbar 310 by penetrating through the insulating cover 500.

The circuit board 700 may be a flexible printed circuit board (FPCB) and may be configured to be bent or folded.

The circuit board 700 may be disposed to face the busbar frame 330 and the insulating cover 500, and at least a portion of the circuit board 700 may be fixed to the busbar frame 330 or the insulating cover 500.

For example, an adhesive member including an adhesive material may be disposed between a bottom surface of the circuit board 700 and the busbar frame 330 or the insulating cover 500, to fix the circuit board 700 to the busbar frame 330 or the insulating cover 500.

Here, the adhesive material may be comprised of an adhesive plate, a sheet, a film, or the like. However, in addition to a fixing method using the adhesive material described above, a circuit board 700 and a support frame 320 may be fixed using various fixing methods (e.g., insertion coupling, bolting, or the like).

According to an embodiment of the present disclosure, the battery module 10 may have a circuit board 700 extending in a first direction (Z-axis direction) in which battery cells 110 are stacked, and be connected to a busbar 310 through the outside of an insulating cover 500, thereby allowing a blocking portion 122 of a protective member 120 to be inserted into a busbar frame 330 without interfering with the circuit board 700, thereby more effectively blocking an indiscriminate flow of high-temperature gases or flames.

Referring to FIGS. 7A, 7B, 8A, 8B, 9A and 9B, along with FIGS. 2 and 3, a circuit board 700 according to an embodiment of the present disclosure may include a body portion 710 disposed above the busbar frame 330, a body portion 710 extending in a direction in which battery cells 110 are stacked, and an extension portion 720 connected to the body portion 710, a portion of which is connected to the busbar 310.

More specifically, the circuit board 700 may include a body portion 710 extending in a first direction (Z-axis direction) in which battery cells 110 are stacked and provided above a busbar 330, and an extension portion 720 connected to the body portion 710, at least a portion of which extends in a second direction (X-axis direction) or a third direction (Y-axis direction), is disposed on the outside of an insulating cover 500, and connected to a busbar 310 by penetrating through the insulating cover 500.

Referring to FIGS. 8A and 8B, the extension portion 720 includes a first extension portion 721 connected to the body portion 710, and a second extension portion 722 connected to the first extension portion 721 and connected to the busbar 310, and the first extension portion 721 and the second extension portion 722 may be bent at a first connection point 731 and extend in different directions.

More specifically, the extension portion 720 may be bent through a first connection point 731, and may include a first extension portion 721 connected to the first connection point 731 and the busbar 310, and a second extension portion 722 connected to the first connection point 731 and the busbar 310, and having a first coupling hole CH1 provided therein.

The circuit board 700 may have a body portion 710 extending in the same direction as the battery cells 110 stacked in a first direction (Z-axis direction), and a plurality of extension portions 720 connected to the body portion 710 disposed in the same direction as the busbars 310 in the first direction (Z-axis direction), thereby connecting the plurality of busbars 310 and the extension portions 720.

Referring to FIGS. 9A and 9B, the extension portion may include a first extension portion, a second extension portion, and a third extension portion, the first extension portion may be connected to the body portion, the third extension portion may be connected to the busbar, the second extension portion may connect the first extension portion and the third extension portion, and the first extension portion and the second extension portion may be disposed above the busbar frame.

More specifically, the extension portion 720 may be bent through a first connection point 731 and a second connection point 732. The extension portion 720 may include a first extension portion 721 connected to the second connection point 732 and the body portion 710, a second extension portion connected to the first connection point 731 and the second connection point 732, and a third extension portion 723 connected to the first connection point 731 and the busbar 310, and having a first coupling hole CH1.

Here, unlike the first connection point 731, the second connection point 732 may have a connecting portion 730 bent in an overlapping manner, and may change the extension direction of the extension portion 720.

The circuit board 700 exemplarily illustrated in FIGS. 9A and 9B may be manufactured into a circuit board 700 having a smaller area than the circuit board 700 exemplarily illustrated in FIGS. 8A and 8B, so that less material may be cut and discarded, and the cost of input materials may be reduced.

The battery module 10 according to an embodiment of the present disclosure may further include a connecting portion 730 connecting different circuit boards 700.

The battery module 10 may include a pair of circuit boards including a body portion 710 and an extension portion 720, and the pair of circuit boards 700 may be provided to be spaced apart from each other in a second direction (X-axis direction). The connecting portion 730 may connect the pair of circuit boards 700 that are spaced apart from each other.

More specifically, the connecting portion 730 may extend in a different direction from the body portion 710 of the circuit board 700.

For example, the body portion 710 may extend in a first direction (Z-axis direction), a stacking direction of the battery cell 110, and the connecting portion 730 may extend in a second direction (X-axis direction), perpendicular to the first direction (Z-axis direction).

However, the extension directions of the body portion 710 and the connecting portion 730 are not limited to that described above, and may be appropriately changed according to the overall structure of the battery module 10.

The connecting portion 730 may extend along one surface of the support frame 320.

For example, the connecting portion 730 may extend along an upper surface of a connecting frame disposed on the upper side of the cell stack 100.

The battery module 10 may further include a sensing member connected to the circuit board 700.

The sensing member may include, for example, one or more temperature sensors 620 configured to sense a temperature and a plurality of sensing terminals 610 configured to detect a voltage of a battery cell 110.

The circuit board 700 may be electrically connected to a sensing member including at least one of a temperature sensor 620 for measuring a temperature or a sensing terminal 610 connected to the plurality of busbars 310 for measuring a voltage.

Meanwhile, in the present specification, “the sensing member… detects” includes not only detecting a specific environmental variable value, but also measuring the size of the environmental variable value as numerical data, and the like, which may mean sensing.

Referring to FIGS. 2 and 3, at least a portion of the temperature sensor 620 be disposed to face the cell stack 100.

Temperature information of the battery cell 110 detected through the temperature sensor 620 may be transmitted to an external component (e.g., BMS) of the battery module 10 through the circuit board 700.

The sensing terminal 610 may be configured to be electrically connected to one or more busbars 310 and a circuit boards 700, respectively, to detect voltage information of the cell stack 100.

The sensing terminal 610 may include a conductive metal material, and be connected to the busbar 310 and the circuit board 700, respectively, to serve as a terminal for voltage detection.

Alternatively, the sensing terminal 610 itself may be configured as a voltage sensor that can generate a signal according to a voltage value.

The sensing terminal 610 may be coupled to the circuit board 700 and the busbar 310, and a portion of the sensing terminal 610 may be welded to the busbar 310.

For example, a portion of the sensing terminal 610 may be coupled to a surface of the busbar 310 by laser welding. However, various methods other than welding may be used as a coupling method between the sensing terminal 610 and the busbar 310.

Since the circuit board 700 may include a material having a relatively lower melting point than the busbar 310, a method other than welding may be applied for the coupling between the sensing terminal 610 and the circuit board 700.

For example, a portion of the sensing terminal 610 may be coupled to the circuit board 700 by soldering. The soldering may be performed using surface mounting technology using solder paste.

In the battery module 10 according to an embodiment of the present disclosure, the circuit board 700 may be coupled to the busbar 310 by penetrating through the outer surface of the insulating cover 500, so that a protective member 120 may be inserted into the busbar frame 330 without interference from the circuit board 700.

Thereby, the protective member 120 may spatially separate the battery cells 110 provided with the protective member 120 interposed therebetween, thereby preventing high-temperature gases or flames from flowing indiscriminately near the cell stack 100 in a thermal runaway situation.

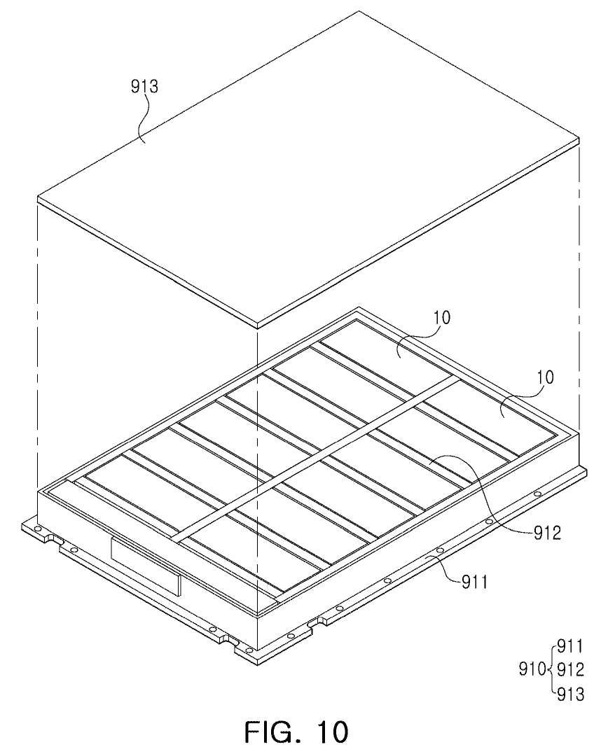

FIG. 10 is a perspective view of a battery pack 900 according to an embodiment of the present disclosure.

FIG. 10 illustrates a battery pack 900 including a battery module 10 including the battery cells 110 described above in FIGS. 1 to 9, and description thereof is omitted to the extent of overlap.

Referring to FIG. 10, the battery pack 900 according to an embodiment of the present disclosure may include a battery module 10 including at least one battery cell 110 described above.

Here, the battery pack 900 may include a plurality of battery modules 10 that are stacked each other and a pack housing 910 formed to surround at least a portion of outer surfaces of the plurality of stacked battery modules 10.

For example, the battery pack 900 of the present disclosure may include a pack housing 910 having a battery module 10 including a battery cell 110 accommodated therein.

The pack housing 910 may include a lower housing 911, a partition wall 912 separating the lower housing 911 into a plurality of loading spaces, and an upper housing 913 covering the lower housing 911.

Meanwhile, unlike the drawing, the battery pack 900 of the present disclosure may be provided in a structure in a form in which the battery cells 110 are directly accommodated (so-called ‘Cell to Pack’).

Meanwhile, the battery pack 900 of the present disclosure is for convenience of understanding, and is not particularly limited as long as the battery pack is a power source including a battery cell 110.

In other words, the battery pack 900 referred to in the present disclosure is not limited to a pack including a battery cell 110, and may include an energy storage system (ESS), an electric vehicle (EV), and the like.

As set forth above, according to the present disclosure, a battery module and a battery pack including the same that can stably discharge high-temperature gases or flames even during thermal runaway, may be provided.

The aforementioned description merely illustrates the technical concept of the present disclosure, and a person skilled in the art to which the present invention pertains may make various modifications and modifications without departing from the essential characteristics of the present disclosure.

Therefore, the example embodiments disclosed in this specification and drawings are not intended to limit but to explain the technical concept of the present disclosure, and the scope of the technical idea of the present disclosure is not limited by these example embodiments. The scope of protection of the present disclosure should be interpreted by the following claims, and all technical ideas within the scope equivalent thereto should be interpreted as being included in the scope of the present disclosure.

What is claimed is:

1. A battery module, comprising:
a cell stack including a plurality of battery cells and at least one protective member disposed between the plurality of battery cells;
a plurality of busbars electrically connected to the plurality of battery cells;
a busbar frame supporting the busbars and the protective member;
an insulating cover facing the busbar frame; and
a circuit board connected to the busbars,
wherein the circuit board is connected to the busbars with the insulating cover interposed therebetween.

2. The battery module of claim 1, wherein a portion of the circuit board is provided on an outer surface of the insulating cover.

3. The battery module of claim 1, wherein the circuit board includes
a body portion disposed above the busbar frame, and extending in a direction in which the battery cells are stacked; and
an extension portion extending from the body portion, a portion of which is connected to the busbar.

4. The battery module of claim 3, wherein the extension portion includes
a first extension portion connected to the body portion; and
a second extension portion connecting the first extension portion and the busbar,
wherein the first extension portion and the second extension portion are bent at a first connection point and extend in different directions.

5. The battery module of claim 3, wherein the extension portion includes a first extension portion, a second extension portion, and a third extension portion,
the first extension portion is connected to the body portion, the third extension portion is connected to the busbar, and the second extension portion connects the first extension portion and the third extension portion, and
the first extension portion and the second extension portion are disposed above the busbar frame.

6. The battery module of claim 3, wherein the extension portion of the circuit board and the busbar are connected through a coupling portion.

7. The battery module of claim 6, wherein the coupling portion includes
a coupling bolt penetrating through the extension portion, the insulating cover, and the busbar; and
a coupling nut connected to the coupling bolt.

8. The battery module of claim 7, wherein the coupling nut is an insert nut.

9. The battery module of claim 7, wherein the coupling portion further comprises
an insulating member covering a portion through which the coupling bolt penetrates and formed of an insulating material.

10. The battery module of claim 1, wherein the busbar frame comprises
a slit hole into which the battery cell is inserted; and
an insertion hole into which the protective member is inserted.

11. The battery module of claim 10, wherein at least one of opposite ends of the protective member is provided to protrude further toward the insulating cover than the slit hole.

12. The battery module of claim 10, wherein a length of the protective member extending in a third direction is formed to be longer than a length of the battery cell extending in a third direction, and
the third direction is a direction perpendicular to a first direction in which the battery cells are stacked and a second direction intersecting lead tabs of the battery cells.

13. The battery module of claim 1, wherein a material of the protective member is formed of a material for blocking propagation of heat or flames between adjacent battery cells.

14. A battery pack, comprising:
a pack housing; and
at least one battery module disposed in the pack housing,
wherein the battery module includes
a cell stack including a plurality of battery cells and at least one protective member disposed between the plurality of battery cells;
a plurality of busbars electrically connected to the plurality of battery cells;
a busbar frame supporting the busbars and the protective member;
an insulating cover facing the busbar frame; and
a circuit board connected to the busbars,
wherein the circuit board is connected to the busbar with the insulating cover interposed therebetween.

15. The battery pack of claim 14, wherein a length of the protective member extending in a third direction is formed to be longer than a length of the battery cell extending in a third direction and is inserted into the busbar frame, and
the third direction is a direction perpendicular to a first direction in which the battery cells are stacked and a second direction intersecting lead tabs of the battery cells.
